(19) United States
(12) Patent Application Publication
(10) Pub. No.: US 2023/0022842 A1
(43) Pub. Date: Jan. 26, 2023

(54) THREADED FASTENER

(71) Applicant: Renewable Energy Systems LLC, Avilla, IN (US)

(72) Inventors: Peter Keller, Fort Wayne, IN (US); Eric Hesher, Avilla, IN (US)

(73) Assignee: Renewable Energy Systems LLC, Avilla, IN (US)

(21) Appl. No.: 17/380,661

(22) Filed: Jul. 20, 2021

(51) Int. Cl. F16B 23/00; F16B 5/02

(52) U.S. Cl. CPC F16B 23/0007; F16B 5/02

(57) ABSTRACT

A threaded fastener system including a female threaded part and a male threaded dual driven fastener. The dual driven fastener has a shaft having a longitudinal axis, a portion of the shaft having a male threaded feature that engages the female threaded part. The male threaded feature having a major thread diameter and a minor thread diameter. There is a first driving feature at a first end of the shaft that is larger than the major thread diameter relative to the longitudinal axis and a second driving feature at a second end of the shaft that is equal to or smaller than the minor thread diameter. The driving features allow torquing of the dual driven fastener from either end.

### BACKGROUND OF THE INVENTION

### 1. Field of the Invention

The present invention relates to fasteners, and, more particularly, to a fastener used with solar panel installations.

### 2. Description of the Related Art

A threaded fastener is a hardware device that mechanically affixes two or more objects together. In general, threaded fasteners are used to create non-permanent joints, which can be removed or dismantled without damaging the joined objects.

Threaded fasteners have a section along the length that has a thread formed thereon. The thread has a pitch, a major diameter and a minor diameter. The threaded portion is mated to a reciprocally formed threaded item by rotating the two relative to each other.

Threaded fasteners often have a head on one end so that the fastener will engage a surface through which it is passed. The head is also often configured to be driven by a driver that engages a feature on the head. However, the head of a blind bolt has no engaging features and is driven by the end opposite the head, such as in U.S. Pat. No. 9,694,478.

What is needed in the art is a fastener that is more versatile to allow fastening in multiple fashions.

### SUMMARY OF THE INVENTION

The present invention provides a threaded fastener that is drivable from either end.

The invention in one form is directed to a threaded fastener system including a female threaded part and a male threaded dual driven fastener. The dual driven fastener has a shaft having a longitudinal axis, a portion of the shaft having a male threaded feature that engages the female threaded part. The male threaded feature having a major thread diameter and a minor thread diameter. There is a first driving feature at a first end of the shaft that is larger than the major thread diameter relative to the longitudinal axis and a second driving feature at a second end of the shaft that is smaller than the minor thread diameter. The driving features allow torquing of the dual driven fastener from either end.

The invention in another form is directed to a dual driven fastener has a shaft having a longitudinal axis, a portion of the shaft having a male threaded feature. The male threaded feature having a major thread diameter and a minor thread diameter. There is a first driving feature at a first end of the shaft that is larger than the major thread diameter relative to the longitudinal axis and a second driving feature at a second end of the shaft that is smaller than the minor thread diameter. The driving features allow torquing of the dual driven fastener from either end.

The invention in yet another form is directed to a method of engaging a fastener having the steps of: threading a female threaded part with a male threaded dual driven fastener, the male threaded dual driven fastener including: a shaft having a longitudinal axis, a portion of the shaft having a male threaded feature that engages the female threaded part, the male threaded feature having a major thread diameter and a minor thread diameter; a first driving feature at a first end of the shaft that is larger in diameter than the major thread diameter; and a second driving feature at a second end of the shaft that is smaller than the minor thread diameter. The method also including the step of torquing the dual driven fastener using either the first driving feature or the second driving feature.

An advantage of the present invention is that either end of the fastener can be driven to tighten or loosen the fastener.

Another advantage is that one end of the fastener can be driven to engage the fastener and the other end can be driven to tightly secure the fastener.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exploded perspective view of an embodiment of a dual drivable fastener according to the present invention;

FIG. 2 is a side perspective view of the dual drivable fastener shown in FIG. 1;

FIG. 3 is a perspective view of another embodiment of a dual drivable fastener of the present invention; and

FIG. 4 is a partially sectioned view of the dual drivable fastener of FIG. 3.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

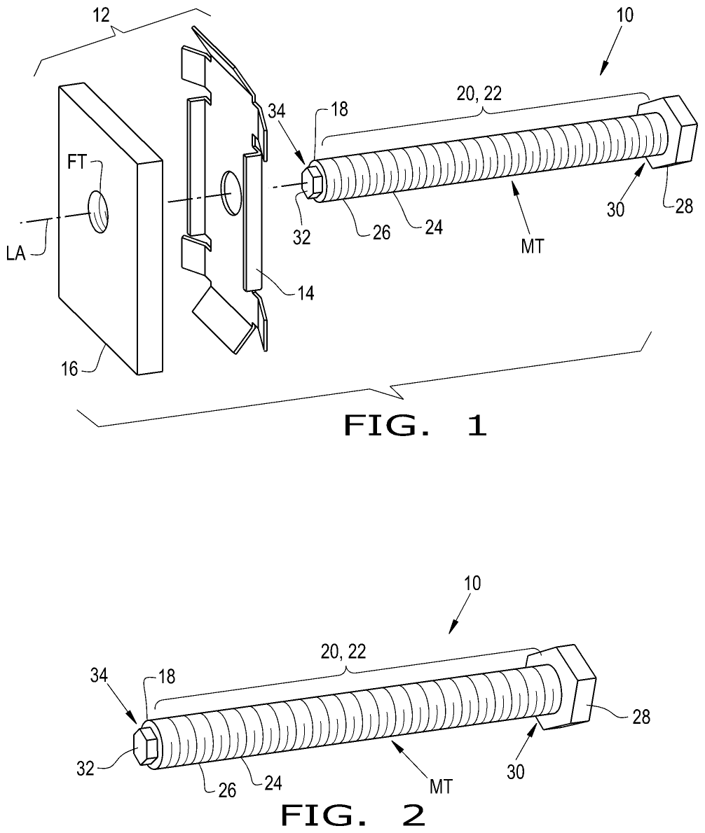

Referring now to the drawings, and more particularly to FIGS. 1-2, there is shown an embodiment of a dual drivable fastener 10 interfacing with a bracket set 12 having a bracket member 14 and a female threaded FT member 16, which may also be thought of as a bracket member 16 having a female threaded portion. Bracket set 12 can be used as part of a mounting system for solar panels, but can be used in other applications as well.

Threaded dual drivable fastener 10, which can simply be considered a threaded fastener 10 has a shaft 18 with a longitudinal axis LA. A portion 20 of shaft 18 having a threaded feature 22. The threaded feature 22 is a male thread MT having a major thread diameter 24 and a minor thread diameter 26, each shown schematically. At the ends of shaft 18 there is a first driving feature 28 at a first end 30 of shaft 18 that is larger than the diameter of major thread diameter 22; and there is a second driving feature 32 at a second end 34 of shaft 18 that is smaller than the minor thread diameter 26. The driving features 28 and 32 allow torquing of fastener 10 from either end of fastener 10. While driving features 28 and 32 are illustrated as a hexagonal shape that can be driven by wrenches, or sockets driven by a driver or drill, other types of driving features as are known can be used.

First driving feature 28 is also known as a head 28 of fastener 10. As illustrated in FIGS. 1 and 2, first driving feature 28 and second driving feature 32 can have a similar shape, here illustrated as hexagonal shapes, but having different sizes. Since driving feature 32 has to be smaller than minor diameter 26, so that driving feature 32 will pass through any opening that will accommodate shaft 18 and become accessible after being threaded through threaded member 16.

Now, additionally referring to FIG. 3, there is shown a second embodiment of the present invention, with the reference characters having 100 added to those of the first embodiment. The corresponding numbers that are offset by 100 are intended to have the same names, but may vary in some regards as discussed herein. Threaded fastener 110 has a first driving feature 128 and a second driving feature 132 having a dissimilar shape, shown here as a hexagonal shape for first driving feature 128, and a square internal shape for second driving feature 132. Second driving feature 132 is recessed into shaft 118. In contrast second driving feature 32 extends from second end 34 of shaft 18.

As previously mentioned second driving feature 32 is shown as having a hexagonal shape, although many other shapes and features are contemplated, including slotted, star, torx, Phillips, and square, among others. In a like manner first driving feature 28 can have a variety of shapes.

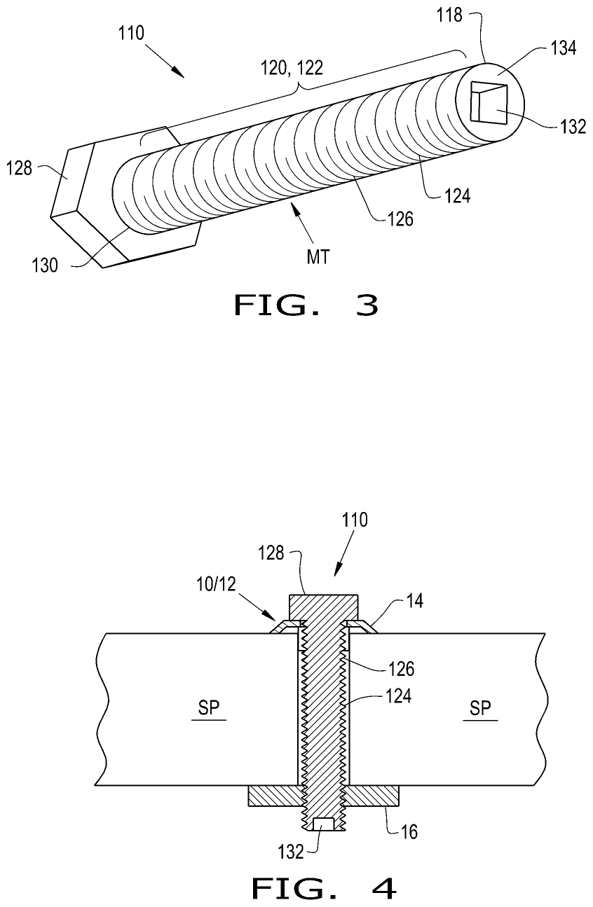

Now additionally referring to FIG. 4, a threaded fastener system 10/12 includes a bracket 14, female threaded part 16 and male threaded dual driven fastener 10, 110 as described above. System 10/12 is being used to couple two solar panels SP, and threaded part 16 may extend to a mounting apparatus for the solar panels SP.

While using system 10/12 the steps of: threading a female threaded part 16 with a male threaded dual driven fastener 10, 110, the male threaded dual driven fastener including the elements discussed above, and torquing the dual driven fastener 10, 110 using either the first driving feature 28, 128 or the second driving feature 32, 132. Both the first driving feature 28, 128 and the second driving feature 32, 132 can be used to rotate the dual driven fastener 10, 110 during the torquing step.

Advantageously the present invention allows for the fastener to be rotatedly driven from either end with the appropriate engaging tool. Installations of items such as solar panels SP have two sides with the access to opposite sides being inconvenient to arrange. As such it is desirable to use the inventive nature of the present invention to allow the fastener to secure the items from either side of the assemblage. In way of further explanation solar panels are arranged at angles so that the underside of the panels are usually easier to access than the topside, hence the advantage of tightening the fasteners from the bottom side.

Surprisingly, such a fastener as described herein has not been discovered in the history of fasteners. The inventive nature of this fastener allows more efficient installation of solar panels, and it is contemplated that this dual drivable fastener can be used in the assembling of other items.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A threaded fastener, comprising:
a shaft having a longitudinal axis, a portion of the shaft having a threaded feature, the threaded feature having a major thread diameter and a minor thread diameter;
a first driving feature at a first end of the shaft that is larger than the major thread diameter; and
a second driving feature at a second end of the shaft that is equal to or smaller than the minor thread diameter, the driving features allow torquing of the fastener from either end.

2. The threaded fastener of claim 1, wherein the first driving feature is a head.

3. The threaded fastener of claim 1, wherein the first driving feature and the second driving feature have a similar shape, but different sizes.

4. The threaded fastener of claim 1, wherein the first driving feature and the second driving feature have a dissimilar shape.

5. The threaded fastener of claim 1, wherein the second driving feature is recessed into the shaft.

6. The threaded fastener of claim 1, wherein the second driving feature extends from the second end of the shaft.

7. The threaded fastener of claim 6, wherein the second driving feature has a hexagonal shape.

8. The threaded fastener of claim 7, wherein the first driving feature has a hexagonal shape.

9. A threaded fastener system, comprising:
a female threaded part; and
a male threaded dual driven fastener including:
a shaft having a longitudinal axis, a portion of the shaft having a male threaded feature that engages the female threaded part, the male threaded feature having a major thread diameter and a minor thread diameter;
a first driving feature at a first end of the shaft that is larger than the major thread diameter relative to the longitudinal axis; and
a second driving feature at a second end of the shaft that is equal to or smaller than the minor thread diameter, the driving features allow torquing of the dual driven fastener from either end.

10. The threaded fastener system of claim 9, wherein the male threaded dual driven fastener is threaded into the female threaded part and then the second driving feature is used to tighten the fastener system.

11. The threaded fastener system of claim 9, wherein the first driving feature is a head.

12. The threaded fastener system of claim 9, wherein the first driving feature and the second driving feature have a similar shape, but different sizes.

13. The threaded fastener system of claim 9, wherein the first driving feature and the second driving feature have a dissimilar shape.

14. The threaded fastener system of claim 9, wherein the second driving feature is recessed into the shaft.

15. The threaded fastener system of claim 9, wherein the second driving feature extends from the second end of the shaft.

16. The threaded fastener system of claim 15, wherein the second driving feature has a hexagonal shape.

17. The threaded fastener system of claim 16, wherein the first driving feature has a hexagonal shape.

18. A method of engaging a fastener, comprising the steps of:
threading a female threaded part with a male threaded dual driven fastener, the male threaded dual driven fastener including:
a shaft having a longitudinal axis, a portion of the shaft having a male threaded feature that engages the female threaded part, the male threaded feature having a major thread diameter and a minor thread diameter;
a first driving feature at a first end of the shaft that is larger in diameter than the major thread diameter; and
a second driving feature at a second end of the shaft that is equal to or smaller than the minor thread diameter; and
torquing the dual driven fastener using either the first driving feature or the second driving feature.

19. The method of engaging a fastener of claim 18, wherein both the first driving feature and the second driving feature are used to rotate the dual driven fastener during the torquing step.

20. The method of claim 19, wherein the first driving feature and the second driving feature have a similar shape, but different sizes.
